(19) United States
(12) Patent Application Publication
(10) Pub. No.: US 2014/0102261 A1
(43) Pub. Date: Apr. 17, 2014

(54) SOCKET TOOL WITH ADJUSTABLE DEPTH

(71) Applicant: TOYOTA MOTOR ENGINEERING & MANUFACTURING NORTH AMERICA, INC., Erlanger, KY (US)

(72) Inventor: Ryan J. Willicombe, Bright (CA)

(73) Assignee: Toyota Motor Engineering & Manufacturing North America, Inc., Erlanger, KY (US)

(21) Appl. No.: 13/652,041

(22) Filed: Oct. 15, 2012

(51) Int. Cl. B25B 13/06; B23P 6/00

(52) U.S. Cl. 81/121.1; 29/402.01

(57) ABSTRACT

An adjustable socket tool with a selectively adjustable depth includes a housing having an elongated passage. A fastener socket is attached to a proximal end of the housing for concurrent rotation therewith and includes an interior region in communication with the elongated passage. The adjustable socket further includes an elongated stop pin slidably disposed within the elongated passage and fixed to the housing for concurrent rotation therewith about a longitudinal axis of the stop pin. The stop pin includes a proximal end arranged proximate the fastener socket so as to operably engage a bolt received within the fastener socket.

### BACKGROUND

Automotive parking brake systems may include a braided cable having one end attached to a vehicle brake mechanism and an opposite end connected to a parking brake lever. The parking brake lever may be selectively manipulated to actuate the parking brake. The parking brake cable may be attached to the parking brake lever using an adjustment nut that threadably engages a stud attached to an end of the parking brake cable. A tension in the parking brake cable may be may be adjusted by selectively tightening and/or loosening the adjustment nut. The tension may be increased by threading the adjustment nut further onto the stud, thereby shortening an effective length of the parking brake cable. Generally, the further the adjustment nut is spaced from a free end of stud the higher the tension in parking brake cable.

The parking brake cable may include multiple wire strands woven together to form a wire cable. A newly manufactured cable typically exhibits a certain amount of inelastic stretching during initial use as the individual wire strands that make up the cable conform to one another. The initial tension in the cable tends to relax as the cable stretches, which may require the cable to be re-tensioned to compensate for stretch in the cable. The need to readjust the parking brake cable tension may be avoided by pre-stretching the parking brake cable during the assembly process by over tightening the adjustment nut. The adjustment nut may then be repositioned on the stud to achieve a desired cable tension. The process of pre-stretching the parking brake cable may involve the use of multiple socket tools having different socket depths.

### SUMMARY

The disclosed exemplary embodiments include an adjustable socket tool having a selectively adjustable socket depth. The adjustable socket tool includes a housing having an elongated passage. A fastener socket is attached to a proximal end of the housing for concurrent rotation therewith. The fastener socket includes an interior region in communication with the elongated passage. The adjustable socket further includes an elongated stop pin slidably disposed within the elongated passage and fixed to the housing for concurrent rotation therewith about a longitudinal axis of the stop pin. The stop pin includes a proximal end arranged proximate the fastener socket so as to operably engage an end of a bolt received within the fastener socket.

Also disclosed is a method for adjusting an automotive parking brake cable tension using the exemplary adjustable socket tool. The method comprises moving a locking pin releasably connecting the stop pin to the housing of the adjustable socket tool to an unlocked position. While maintaining the locking pin in the unlocked position, the stop pin may be moved toward a deep socket position in which the proximal end of the stop pin is spaced a first distance from the fastener socket. The stop pin may be retained in the deep socket position by moving the locking pin to a locked position. A nut for adjusting tension in the parking brake cable may be driven to a first distance from an end of the bolt using the adjustable socket tool set at the deep socket position. The stop pin may then be moved to a shallow socket position in which the proximal end of the stop pin is spaced a second distance from the fastener socket by moving the locking pin to the unlocked position and sliding the stop pin to the shallow socket position. The first distance is greater than the second distance. The stop pin may be retained in the shallow socket position by moving the locking pin to the locked position. The nut may be driven to the second distance from the end of the bolt using the adjustable socket tool adjusted to the shallow socket depth.

### BRIEF DESCRIPTION OF THE DRAWINGS

The description herein makes reference to the accompanying drawings wherein like reference numerals refer to like parts throughout the several views, and wherein:

FIG. 1 is a schematic perspective view of an exemplary adjustable socket tool having a selectively adjustable socket depth;

FIG. 2 is a side cross-sectional view of the adjustable socket tool taken along section 2-2 of FIG. 1 illustrating a stop pin arranged in a shallow socket position;

FIG. 3 is a schematic end view of the adjustable socket tool viewed from a hex drive end of the adjustable socket tool;

FIG. 4 is a schematic end view of the adjustable socket tool viewed from a fastener socket end of the tool;

FIG. 5 is a schematic partial side view of the adjustable socket tool;

FIG. 6 is a schematic partial side view of the adjustable socket tool viewed from a side opposite the view illustrated in FIG. 5;

FIG. 7 is a schematic partial cross-sectional view of the adjustable socket tool taken along section 7-7 of FIG. 2, illustrating a locking pin arranged in a locked position;

FIG. 8 is a schematic partial cross-sectional view of the adjustable socket tool taken along section 8-8 of FIG. 2;

FIG. 9 is a schematic partial cross-sectional view of the adjustable socket tool taken along section 9-9 of FIG. 2;

FIG. 10 is a schematic partial cross-sectional view of the adjustable socket tool illustrating the stop pin arranged in a deep socket position;

FIG. 11 is schematic partial cross-sectional view of the adjustable socket tool illustrating the lock pin arranged in an unlocked position;

FIG. 12 is schematic partial cross-sectional view of the adjustable socket tool, with the stop pin arranged in the shallow socket, illustrating a fastener and corresponding bolt disposed within the fastener socket;

FIG. 13 is a schematic partial cross-sectional view of the adjustable socket tool, with the stop pin arranged in the deep socket position, illustrating a nut of the fastener of FIG. 12 disposed outside an end of the fastener socket and an end of a bolt associated with the fastener engaging an end of the stop pin; and

FIG. 14 is a schematic side view of an exemplary parking brake mechanism.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present invention. Further, the descriptions set forth herein are not intended to be exhaustive or otherwise limit or restrict the claims to the precise forms and configurations shown in the drawings and disclosed in the following detailed description.

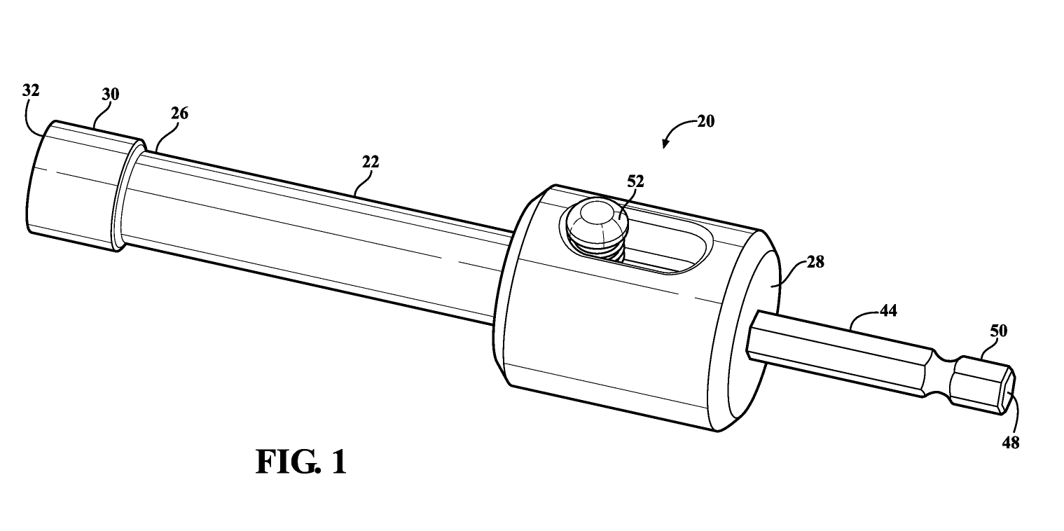

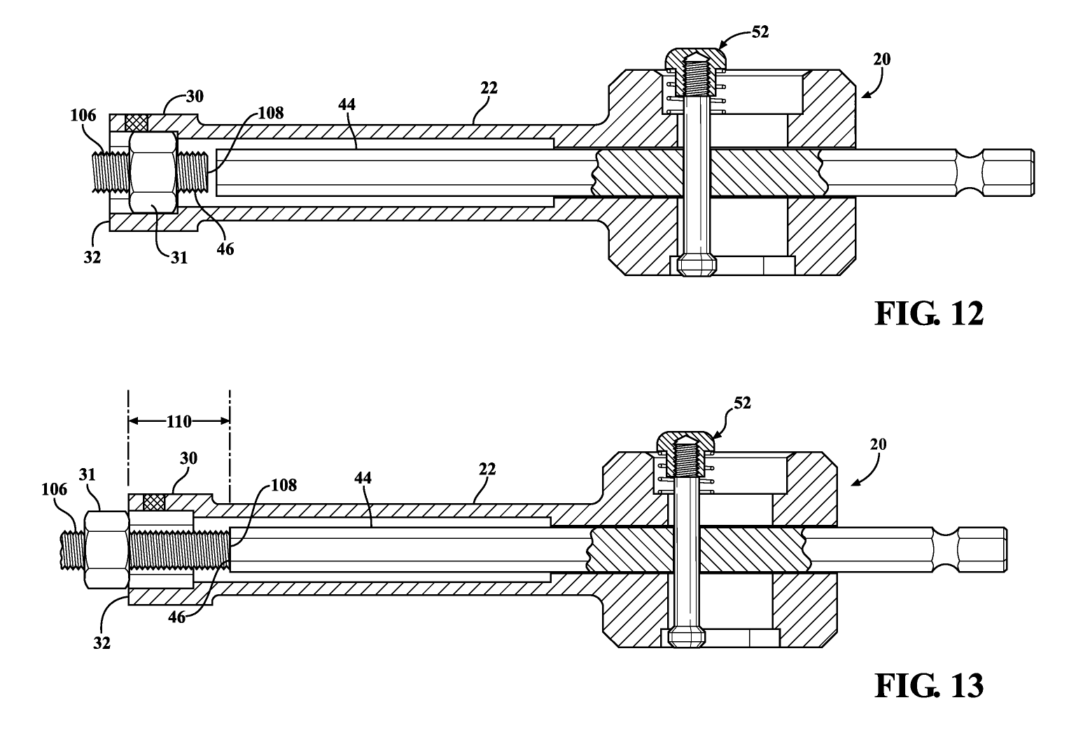

Referring to FIGS. 1-4, an exemplary adjustable socket tool 20 may include a housing 22 having an elongated internal passage 24 extending lengthwise along a longitudinal axis A-A of housing 22. Internal passage 24 may extend entirely through housing 22 from a proximal end 26 to an opposite distal end 28. Attached to proximal end 26 is a fastener socket 30 configured for receiving a threaded fastener, such as, for example, a conventional hex nut 31, as illustrated in FIGS. 12 and 13. Fastener socket 30 may be releasably connected to housing 22. Alternatively, fastener socket 30 may be fixedly attached to housing 22, such as by welding, brazing, soldering and gluing, to name a few, or integrally formed with housing 22. Providing a detachable connection between fastener socket 30 and housing 22 enables multiple fastener sockets having different configurations to be used with a single adjustable socket tool 20. For purposes of discussion, fastener socket 30 is illustrated as being integrally formed with housing 22, but as previously described, fastener socket 30 may also be removably connected. The connection method employed should be capable of transmitting a rotational torque from housing 22 to fastener socket 30. The employed connection method should operate to rotatably fix fastener socket 30 to housing 22 to enable the two components to rotate concurrently in response to a rotational torque applied to housing 22.

Fastener socket 30 may have a generally cylindrical shape with an open proximal end 32 and an opposite open distal end 34. Distal end 34 may be located adjacent proximal end 26 of housing 22, with proximal end 32 of fastener socket 30 spaced from proximal end 26 of housing 22. Fastener socket 30 includes a wall 36 having an interior surface 38 at least partially defining an internal cavity 40 for receiving a fastener, for example, fastener 31 illustrated in FIGS. 12 and 13. Internal cavity 40 may be connected to internal passage 24 of housing 22 through open distal end 34 of fastener 30. A magnet 41 may be attached to wall 36 to help retain the fastener within internal cavity 40.

Interior surface 38 of wall 36 may be suitably contoured to engage the fastener received within internal cavity 40. A step 42 may be provided along interior surface 38 adjacent distal end 34 of fastener socket 30 to act as a stop and prevent the fastener from entering internal passage 24 of housing 22.

Interior surface 38 may include various geometric features that engage corresponding features on the fastener to rotatably lock the fastener to fastener socket 30, whereby the two members rotate in substantial unison when fastener socket 30 is rotated about longitudinal axis A-A. For example, interior cavity 40 may be configured for receiving a conventional hex nut by it with a hexagonal contour corresponding to the outer circumferential contour of the hex nut. The non-circular circumferential contour rotatably locks the fastener to fastener socket 30 and enables rotational torque from housing 22 to be transferred through fastener socket 30 to the fastener. In practice, the configuration of internal cavity 40 may be varied to accommodate a selected fastener configuration.

With continued reference to FIGS. 1-4, adjustable socket tool 20 may include an elongated stop pin 44 disposed within internal passage 24 of housing 22. A longitudinal axis of stop pin 44 may substantially coaxially align with longitudinal axis A-A. A proximal end 46 of stop pin 44 is positioned adjacent fastener socket 30 and an opposite distal end 48 extends out from internal passage 24 and beyond distal end 28 of housing 22 so as to be accessible by a user.

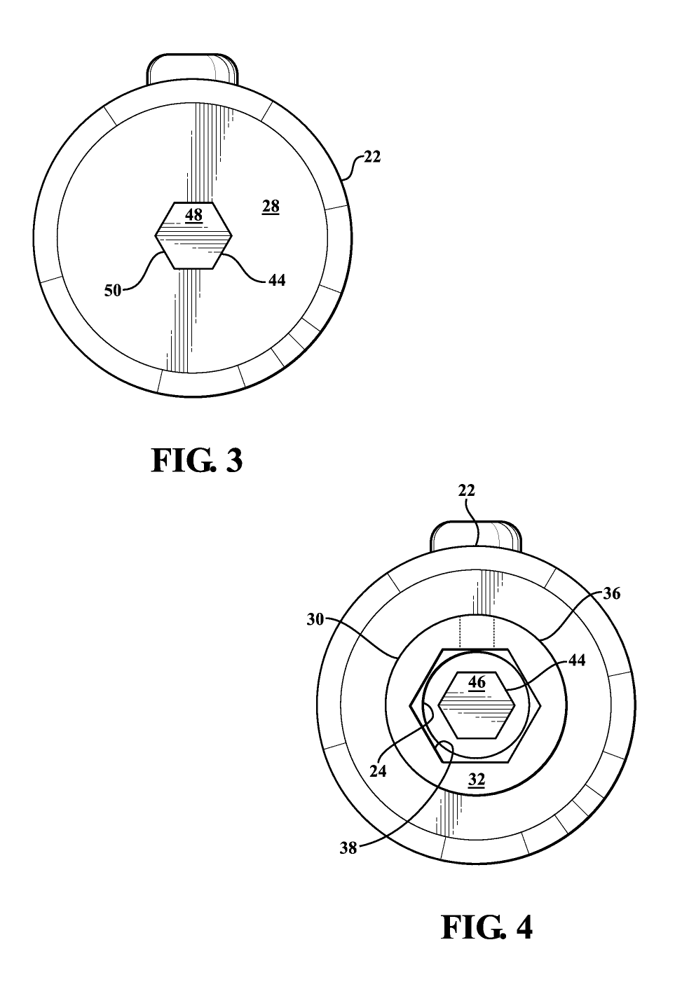

Distal end 48 of stop pin 44 may include a connector 50 configured to releasably engage a separate tool operable for applying a rotational torque to stop pin 44. The exemplarily configured connector 50 includes a generally hexagonal cross-sectional shape when viewed from the perspective of FIG. 3. The hexagonally-shaped connector 50 may engage a correspondingly shaped socket on a tool for rotatably driving stop pin 44. This is but one example of the various connector configurations that may be employed with connector 50. In practice, the configuration of connector 50 may be selected to match the configuration of the corresponding connector on the tool for rotatably driving stop pin 44.

Stop pin 44 may be rotatably fixed to housing 22 for concurrent rotation about longitudinal axis A-A while being moveable axially along longitudinal axis A-A within internal passage 24. Stop pin 44 may include various geometric features arranged along an outer circumferential perimeter 45 of stop pin 44 that lockingly engage, in a circumferential direction, corresponding features positioned along an internal circumferential perimeter 47 of internal passage 24. The locking features cooperatively interact to substantially prevent stop pin 44 from rotating within internal passage 24 relative to housing 22. The locking features are configured so as to not substantially hinder stop pin 44 from moving axially within internal passage 22 along longitudinal axis A-A. By way of example, stop pin 44 may employ a non-circular outer circumferential perimeter 45, such as the hexagon shape illustrated in FIG. 8, which engages a correspondingly configured region within internal passage 24. Stop pin 44 may be sized slightly smaller that internal passage 24 in housing 22 to enable stop pin 44 to move axially along longitudinal axis A-A, but not so small as to allow stop pin 44 to rotate within internal passage 24. Stop pin 44 and internal passage 24 may alternatively employ other non-circular cross-sectional shapes, for example, square, rectangular, triangular and polygonal, to name a few.

It is not necessary that stop pin 44 and internal passage 24 employ geometrically matching cross-sections, so long as the rotational locking feature on stop pin 44 rotationally locks with the corresponding locking feature on internal passage 24. For example, the rotational locking feature may include one or more pins extending radially outward from stop pin 44 that slidably engage one or more elongated axially oriented slots formed in a sidewall of internal passage 24. Other mechanisms for rotatably locking stop pin 44 relative to housing 22 may also be employed.

With reference also to FIG. 9, it is not necessary that internal passage 24 have a consistent uniform cross-sectional area along its entire axial length. For example, the cross-sectional area of passage 24 in a vicinity of fastener socket 30 may be larger than a cross-sectional area at an opposite end of the passage. Increasing the cross-sectional area adjacent fastener socket 30 may provide additional clearance to allow a fastener bolt dimensioned larger than stop pin 44 to protrude into passage 24 and contact proximal end 46 of stop pin 44, as discussed in more detail subsequently.

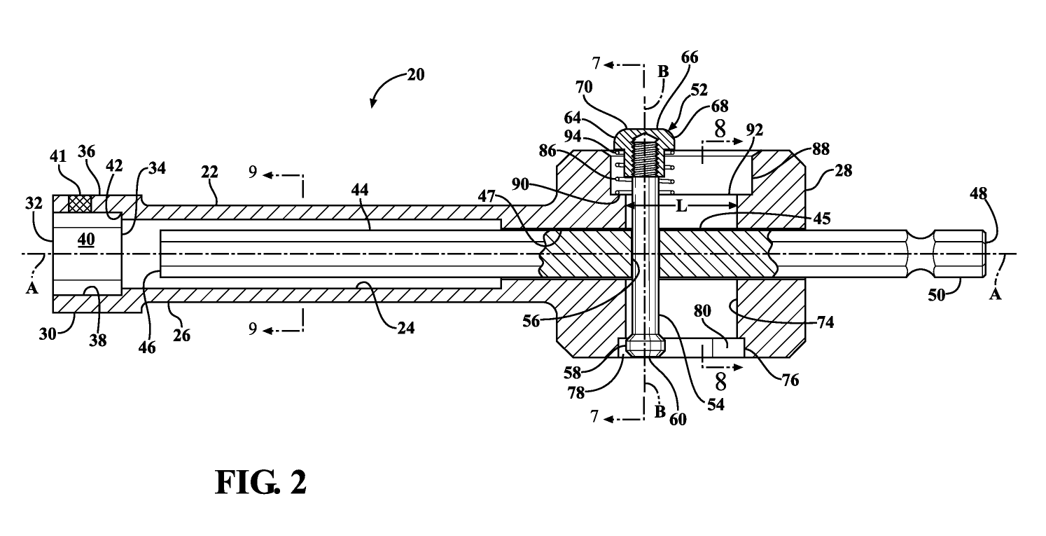

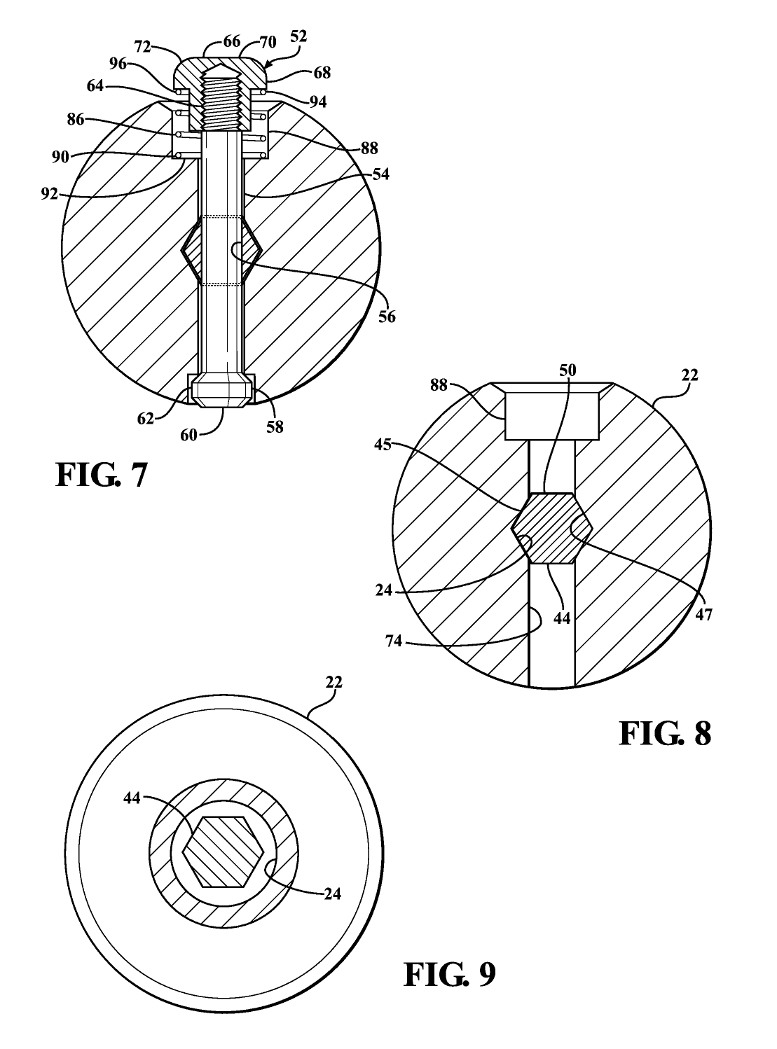

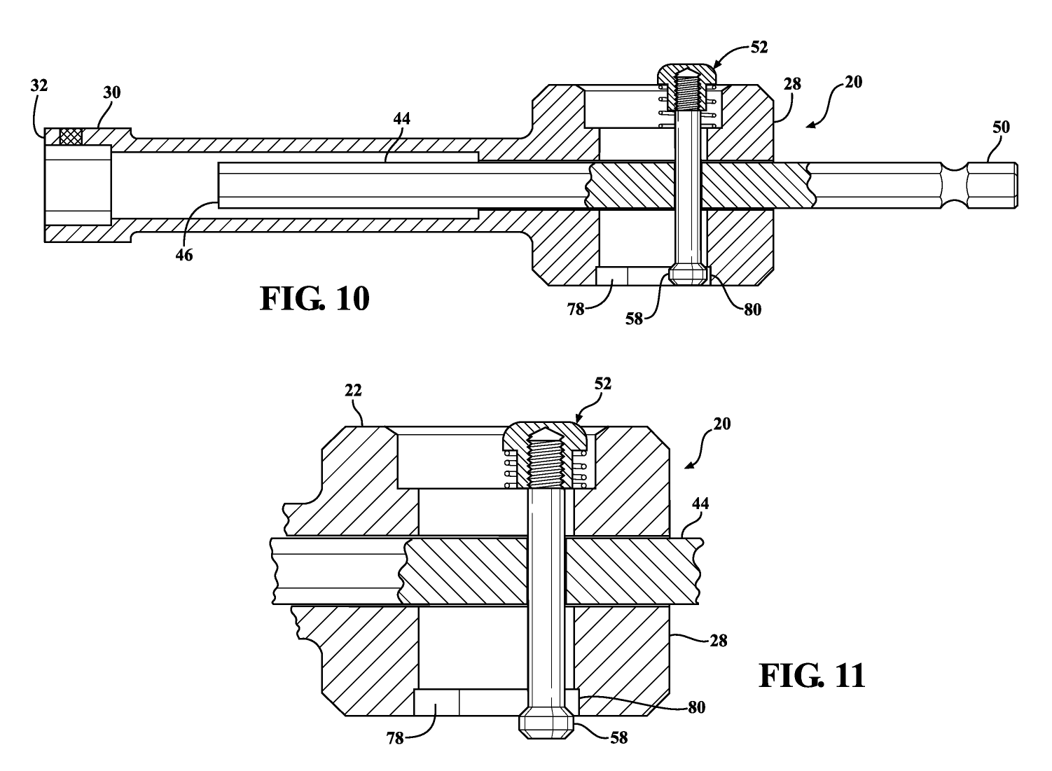

With reference to FIGS. 2 and 7, adjustable socket tool 20 may include a locking pin 52 operable for releasably securing stop pin 44 in two or more axial positions relative to fastener socket 30, for example, a shallow socket position as illustrated in FIGS. 2, 12 and 13, and a deep socket position as illustrated in FIGS. 10 and 11. Locking pin 52 may be selectively moved along a longitudinal axis B-B between a locked position, for example, as illustrated in FIGS. 2, 7, 10, 12 and 13, and an unlocked position, for example, as illustrated in FIG. 11. Locking pin 52 may include an elongated stem 54 slidably engaging an aperture 56 extending through stop pin 44. A longitudinal axis of stem 54 coinciding with longitudinal axis B-B may be oriented substantially perpendicular to longitudinal axis A-A. A flange 58 extends radially outward from a distal end 60 of stem 54. At least a portion of an outer circumference 62 of flange 58 has a larger diameter than a diameter of stem 54.

Attached to a proximal end 64 of stem 54 opposite flange 58 is an actuating button 66 that can be manipulated by a user to actuate locking pin 52. Actuating button 66 and flange 58 are arranged on opposite sides of stop pin 44. Actuating button 66 may include a flange 68 extending generally radially outward relative to longitudinal axis B-B. An upper surface 70 of actuating button 66 is accessible by a user. The user can press down on upper surface 70, for example with the person's finger, to move the locking pin toward the unlocked position. An upper circumferential edge 72 of actuating button 66 may be chamfered or radiused to avoid sharp edges that may cause discomfort or irritation to the user when manipulating locking pin 52. Actuating button 66 may be threadably attached to proximal end 64 of stem 54, or alternatively, may be fixedly attached using another attachment mechanism, for example, brazing, gluing, soldering and welding, to name a few.

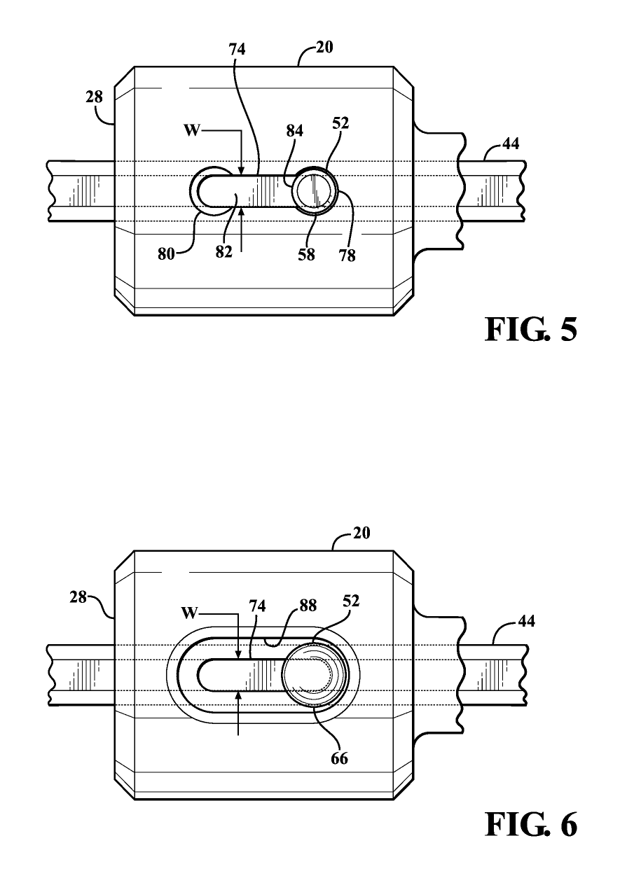

With reference to FIGS. 2, 5 and 6, housing 20 may include a generally oval-shaped locking pin slot 74 (when viewed from a side perspective of housing 22, for example, as illustrated in FIGS. 5 and 6) extending radially through housing 22. Locking pin 52 is slidably disposed within locking pin slot 74. Locking pin slot 74 may be dimensioned to have a width “W” that is larger than a diameter of stem 54. Locking pin slot 74 provides clearance between housing 22 and stem 54 to enable locking pin 52 to move axially along longitudinal axis A-A and radially along longitudinal axis B-B. Locking pin slot 74 has a length “L” (see FIG. 2) dimensioned to accommodate a desired range of motion of stop pin 44 along longitudinal axis A-A.

With continued reference to FIGS. 2 and 5, a distal end 76 of locking pin slot 74 may include multiple spaced apart recessed detents, for example, a first detent 78 and a second detent 80, which cooperatively interact with flange 58 of locking pin 52 for releasably retaining stop pin 44 in a selected axial location relative to fastener socket 30. First detent 78 is operable for retaining stop pin 44 in the shallow socket position and second detent 80 is operable for retaining stop pin 44 in the deep socket position. Detents 78 and 80 may be axially spaced along a common plane coinciding with longitudinal axis A-A. Two detents 78 and 80 are employed in the exemplarily configured adjustable socket tool 20, but in practice, more detents may be provided to accommodate a wider selection of axial positions for releasably securing stop pin 44 relative to fastener socket 30.

Detents 78 and 80 may be formed as a recessed pocket dimensioned to receive flange 58 of stem 54. Detents 78 and 80 include an opening 82 and 84, respectively, dimensioned sufficiently large to allow stem 54, but not flange 58, to pass through the opening. An axial position of stop pin 44 may be selectively fixed relative fastener socket 30 by engaging flange 58 of stem 54 with the respective detents 78 and 80. Disengaging flange 58 from the detents 78 and 80 allows stop pin 44 to move axially along longitudinal axis A-A.

A biasing member 86 may be employed for urging locking pin 52 toward the locked position in which flange 58 is received within detent 78 or 80. Biasing member 86 may be configured as a conventional coil spring, or may alternatively include another configuration. Biasing member 86 may be disposed between housing 22 and button actuating button 66 of locking pin 52. Housing 22 may include an elongated generally oval-shaped (as viewed from the perspective of FIG. 6) clearance slot 88 for providing clearance between housing 22 and biasing member 86 to enable locking pin 52 to slide axially along longitudinal axis A-A without biasing member 88 interfering with housing 22. One end 90 of biasing member 86 may engage a bottom surface 92 of clearance slot 88 and an opposite end 94 may engage an underside surface 96 of actuating button flange 68. The biasing forced exerted on actuating button 66 tends to urge locking pin 52 toward the locked position. Locking pin 52 may be moved to the unlocked position by applying a generally axial force to upper surface 70 of actuating button 66 sufficient to overcome the biasing force generated by biasing member 86, for example, by a user depressing the actuating button with a finger.

With reference to FIGS. 2, 10 and 11, stop pin 44 may be selectively moved between the shallow socket position, for example, as illustrated in FIG. 2, and the deep socket position, for example, as illustrated in FIG. 10. Stop pin 44 may be secured in the shallow and deep socket positions by releasably engaging flange 68 on stem 54 of locking pin 52 with the respective detent 78 and 80. Stop pin 44 may be moved from the shallow socket position, for example, as illustrated in FIG. 2, to the deep socket position, for example, as illustrated in FIG. 10, by depressing actuating button 66 to move stem 54 axially downward (as viewed from the perspective of FIGS. 2, 10 and 11) along longitudinal axis B-B to disengage flange 58 from detent 78, for example, as illustrated in FIG. 11. With locking pin 52 positioned in the unlocked position stop pin 44 may be moved axially within internal passage 24 to the deep socket position. Releasing locking pin 52 allows stem 54 to move axially upward (as viewed from the perspective of FIGS. 2, 10 and 11) along longitudinal axis B-B in response to the biasing force exerted by biasing member 94 to engage flange 58 with detent 78, for example, as illustrated in FIG. 10. Stop pin 44 may be moved from the deep socket position to the shallow socket position by reversing the process. Namely, by depressing locking pin 52 to disengage flange 58 from detent 80 and sliding stop pin 44 forward toward fastener socket 30 to the shallow socket position. Stop pin 44 may be retained in the shallow socket position by releasing locking pin 52 to engage flange 58 with detent 78.

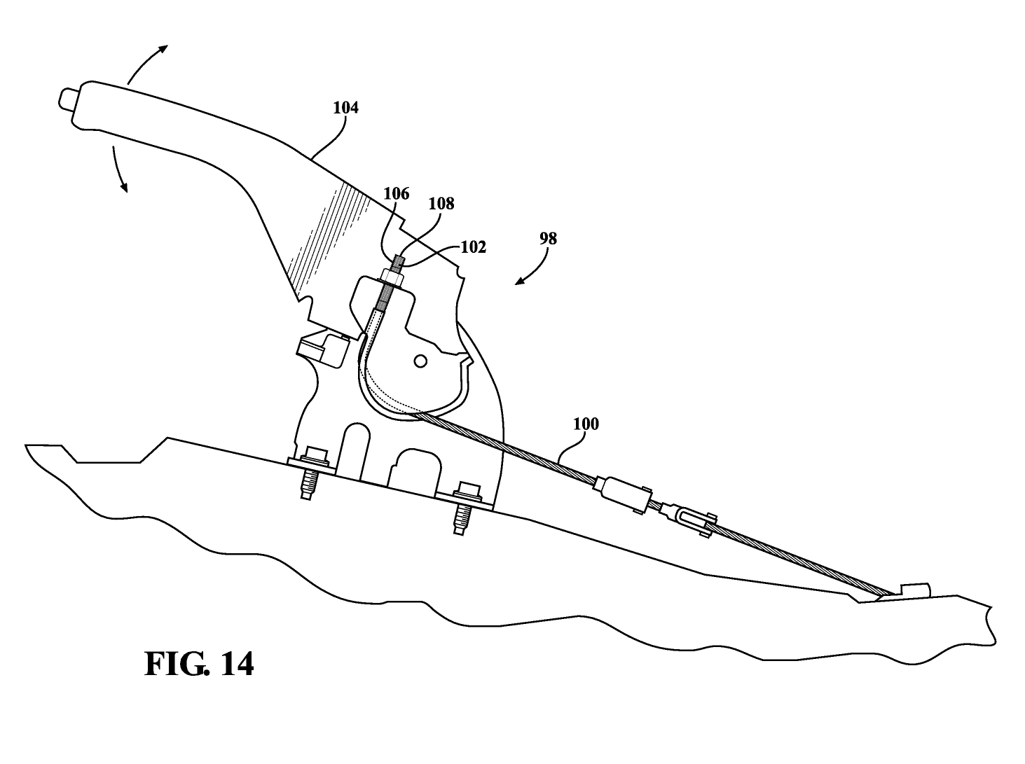

Exemplary adjustable socket tool 20 may be used in a variety of applications, including but not limited to, adjusting a cable tension of an automotive parking brake system. An exemplary automotive parking brake system 98 is schematically illustrated in FIG. 14. Parking brake system 98 may include a cable 100 having one end attached to a vehicle brake mechanism and an opposite end 102 connected to a parking brake lever 104. Parking brake lever 104 may be selectively manipulated to actuate the parking brake. Cable 100 may be attached to parking brake lever 104 using nut 31 that threadably engages a stud 106 attached to end 102 of cable 100. A tension in cable 100 may be adjusted by selectively tightening and/or loosening nut 31. The tension may be increased by threading nut 31 further onto stud 106, thereby shortening an effective length of cable 100. Generally, the further nut 31 is spaced from end 108 of stud 106 the higher the tension in cable 100.

Cable 100 may include multiple wire strands woven together to form a wire cable. A newly manufactured wire cable typically exhibits a certain amount of inelastic stretching during initial use as the individual wire strands that make up the wire cable conform to one another. The initial tension in the wire cable tends to relax as the cable stretches, which may require the cable to be re-tensioned to compensate for the stretch in the cable. The need to readjust the cable tension may be avoided by pre-stretching cable 100. This may be accomplished using the selectively adjustable socket depth features of adjustable socket tool 20.

Cable 100 may be pre-stretched by threading nut 31 onto stud 106 and positioning nut 31 at a pre-stretch position located a first distance from end 108 of stud 106. The pre-stretch position is located further from end 108 of stud 106 than a position of nut 31 when located in a tension setting position for approximately achieving a desired cable tension. The pre-stretch operation may include an operator adjusting adjustable socket tool 20 to position stop pin 44 in the deep socket position (see FIG. 10) in the manner described above. Fastener socket 30 is engaged with nut 31 and adjustable socket tool 20 is rotatably driven to thread nut 31 onto stud 106 to the pre-stretch position located at the first distance from end 108 of stud 106. Nut 31 may be threaded far enough onto stud 106 during the pre-stretch process to cause end 108 of stud 106 to contact distal end 46 of stop pin 44, but not so far as to cause nut 31 to run out from proximal end 32 of fastener socket 30.

The tension in cable 100 may be approximately set to a desired tension after completing the pre-stretch operation by repositioning nut 31 on stud 106 to the tension setting position at a second distance 110 (see FIG. 13) from end 108 of stud 106. Second distance 110 corresponding to the tension setting position is generally less than the first distance corresponding to the pre-stretch position. Adjustable socket tool 20 may be used to move nut 31 along stud 106 to reposition nut 31on stud 106 prior to moving the nut to the tension setting position. With fastener socket 30 engaging nut 31, adjustable tool 20 may be rotated about longitudinal axis A-A to move nut 31 from the pre-stretch position on stud 106 to a pre-tension setting position at a third distance from end 108 of stud 106. The third distance corresponding to the pre-tension setting position is less than the second distance 110 corresponding to the tension setting position.

To set nut 31 in the tension position, an operator may first adjust adjustable socket tool 20 to position stop pin 44 in the shallow socket position (see FIG. 12) in the manner describe above. Fastener socket 30 may be engaged with nut 31 and adjustable socket tool 20 may be rotated about longitudinal axis A-A to move nut 31 from the pre-tension setting position to the tension setting position. Prior to nut 31 reaching the tension setting position, end 108 of stud 106 contacts proximal end 46 of stop pin 44, which prevents stud 106 from extending further into internal passage 24. Continuing to thread nut 31 onto stud 106 causes nut 31 to run out from proximal end 32 of fastener socket 30, thereby setting 31 at the tension setting position.

It is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

The foregoing description relates to what is presently considered to be the most practical embodiment. It is to be understood, however, that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An adjustable socket tool comprising:
a housing including an elongated passage;
a fastener socket attached to the housing for concurrent rotation therewith, the fastener socket including an interior region in communication with the elongated passage; and
an elongated stop pin slidably disposed within the elongated passage, the stop pin fixed to the housing for concurrent rotation therewith about a longitudinal axis of the stop pin and having a proximal end arranged proximate the fastener socket so as to operably engage a bolt received within the fastener socket.

2. The adjustable socket tool of claim 1 further comprising a locking pin slidably engaging the stop pin, the locking pin selectively moveable between a locked position in which the stop pin is releasably connected to the housing to substantially prevent axially movement of the stop pin relative to the housing, and an unlocked position in which the stop pin is free to move axially relative to the housing.

3. The adjustable socket tool of claim 2, wherein the locking pin is fixed for concurrent axial movement with the stop pin along a longitudinal axis of the stop pin, such that movement of the locking pin along the longitudinal axis of the stop pin produces a corresponding axial movement of the stop pin.

4. The adjustable socket tool of claim 2, wherein a distal end of the stop pin is positioned outside the housing and includes a connector for receiving a tool operable for applying a rotational torque to the stop pin.

5. The adjustable socket tool of claim 2, wherein the locking pin further includes a flange selectively engagable with a locking detent in the housing, the flange on the locking pin engaging the locking detent when the locking pin is arranged in the locked position, and the flange disengaged from the locking detent when the locking pin is arranged in the unlocked position.

6. The adjustable socket tool of claim 5, further comprising a biasing member operably connected to the locking pin, the biasing member operable for urging the locking pin toward the locked position.

7. The adjustable socket tool of claim 6, wherein the biasing member and the flange on the locking pin are located on opposite sides of the stop pin.

8. An adjustable socket tool comprising:
a fastener socket having an interior cavity for receiving a fastener; and
an elongated stop pin fixed to the fastener socket for concurrent rotation therewith, the stop pin selectively moveable axially along its longitudinal axis relative to the fastener socket, the stop pin including a proximal end in communication with an interior cavity of the fastener socket and a user accessible distal end opposite the proximal end, the distal end including a connector for receiving a tool operable to apply a rotational torque to the stop pin.

9. The adjustable socket tool of claim 8 further comprising a housing connecting the stop pin to the fastener socket, wherein the stop pin is selectively moveable along its longitudinal axis relative to the housing.

10. The adjustable socket tool of claim 9, wherein the stop pin is fixed to the housing for concurrent rotation therewith.

11. The adjustable socket tool of claim 9, wherein the housing includes an elongated passage in communication with the interior cavity of the fastener socket, the stop pin slidably disposed within the elongated passage and moveable between a first position in which the proximal end is positioned a first distance from the fastener socket and a second position in which the proximal end is positioned a second distance from the fastener socket, the second distance being greater than the first distance.

12. The adjustable socket tool of claim 11 further comprising a locking pin slidably engaging the stop pin, the locking pin selectively moveable between a locked position for securing the stop pin in at least one of the first and second positions, and an unlocked position for moving the stop pin between the first and second positions.

13. A method for adjusting an automotive parking brake cable tension using an adjustable socket tool, the method comprising:
actuating a locking pin releasably connecting a stop pin to a housing of the adjustable socket tool to an unlocked position;
moving the stop pin slidably disposed within the housing of the adjustable socket tool toward a deep socket position in which a proximal end of the stop pin is displaced a first distance from a fastener socket while maintaining the locking pin in the unlocked position;
driving a nut threadably attached to a bolt for adjusting a tension of the parking brake cable to a first distance from an end of the bolt using the adjustable socket tool;
moving the stop pin toward a shallow socket position in which the proximal end of the stop pin is displaced a second distance from the fastener socket while maintaining the lock pin in the unlocked position, the second distance being greater than the first distance; and
driving the nut to a second distance from the end of the bolt using the adjustable socket tool, the first distance from the bolt end being greater than the second distance from the bolt end.

14. The method of claim 13, wherein moving the stop pin comprises displacing the lock pin axially relative to a longitudinal axis of the stop pin.

15. The method of claim 13 further comprising actuating the locking pin to a locked position when the stop pin is positioned in at least one of the shallow and deep socket positions.

16. The method of claim 13, wherein driving the nut to the second distance from the bolt end comprises driving the nut until an end of the bolt engages a proximal end of the stop pin and the nut runs out an end of the fastener socket.

17. The method of claim 13, wherein driving the nut comprises applying a rotational torque to the stop pin.

18. The method of claim 13 further comprising driving the nut to a third distance from the end of the bolt using the adjustable socket tool prior to driving the nut to the second distance from the end of the bolt, wherein the second distance is greater than the third distance.

19. The method of claim 13 further comprising engaging the fastener socket with the nut prior to driving the nut to at least one of the first and second distances from the bolt end.

20. The method of claim 13 further comprising disengaging the fastener socket from the nut prior to moving the stop pin to at least one of the first and second positions.
